(19) United States
(12) Patent Application Publication
(10) Pub. No.: US 2016/0379314 A1
(43) Pub. Date: Dec. 29, 2016

(54) METHODS AND APPARATUS FOR SURFACING INCOMPLETE FEEDBACK REQUESTS IN A SOCIAL MEDIA ENVIRONMENT

(71) Applicant: salesforce.com, inc., San Francisco, CA (US)

(72) Inventors: Lorne Keith Trudeau, Bainbridge Island, WA (US); Yechiel C. Bitton, San Francisco, CA (US); Corey Montel Pearson, Oakland, CA (US); Darshil Vipul Vora, San Francisco, CA (US); Jamie No, Mill Creek, WA (US); Jill Blue Lin, Berkeley, CA (US); Matthew Stein, San Francisco, CA (US); Niyati Ninad Bedekar, San Ramon, CA (US); Yakaira Nunez, New Orleans, LA (US); Yurika Sebata-Dempster, San Francisco, CA (US)

(73) Assignee: SALESFORCE.COM, INC., San Francisco, CA (US)

(21) Appl. No.: 14/748,561

(22) Filed: Jun. 24, 2015

(51) Int. Cl. G06Q 50/00

(52) U.S. Cl. CPC G06Q 50/01

(57) ABSTRACT

A method for introducing action items via a social media interface of a social media platform is provided. The method detects, at a server, an incomplete feedback request submitted to the social media platform, wherein the incomplete feedback request lacks response, and wherein the social media platform is connected to the server; generates an action item post from the incomplete feedback request; and provides, by the server over a network, the action item post via the social media interface.

### TECHNICAL FIELD

Embodiments of the subject matter described herein relate generally to presenting feedback requests to social media users. More particularly, embodiments of the subject matter relate to presenting incomplete feedback requests to users of a social media platform.

### BACKGROUND

Use of social media tends to be fast-paced, with frequently changing new content dominating the display. Most social media platforms call attention to the most recently posted content using posting placement and/or user notifications. For example, the most recent posts are generally placed at the top of a “feed” of posts, whether the feed is located on a user profile page, a “wall”, or another social media location. A user may also receive an alert when new content is posted that is relevant to that particular user. Social media postings may include text-based messages regarding “status”, personal commentary, requests for feedback, or the like. Postings may also include content sharing, such as, for example, pictures, files, video, links, etc.

Because users may not access their social media accounts constantly, or even regularly, posts from other users can be missed as they are shifted down a feed to accommodate more recent posts. This is challenging for users whose posts require feedback, because their posts may be ignored if other users in their network do not log in for a period of time.

Accordingly, it is desirable to provide additional access to aged social media posts requesting feedback. Furthermore, other desirable features and characteristics will become apparent from the subsequent detailed description and the appended claims, taken in conjunction with the accompanying drawings and the foregoing technical field and background.

### BRIEF SUMMARY

Some embodiments of the present invention provide a method for introducing action items via a social media interface of a social media platform. The method detects, at a server, an incomplete feedback request submitted to the social media platform, wherein the incomplete feedback request lacks response, and wherein the social media platform is connected to the server; generates an action item post from the incomplete feedback request; and provides, by the server over a network, the action item post via the social media interface.

Some embodiments provide a system for introducing feedback requests in a social media platform. The system includes: a social media interface presented by a server over a network, the social media interface configured to: receive, and communicate to the server, user input comprising social media activity; and display social media posts submitted to the social media platform, the social media platform being connected to the server; a detection module of the server, configured to detect an incomplete feedback request submitted to the social media platform, wherein the social media posts comprise at least the incomplete feedback request; and a presentation module of the server, configured to display the incomplete feedback request as a new social media post.

Some embodiments provide a non-transitory, computer-readable medium containing instructions thereon, which, when executed by a processor, are capable of performing a method. The method identifies an aged feedback request submitted to a social media platform connected to a server, wherein the aged feedback request lacks a required number of responses; and presents, by the server, the aged feedback request as a new feedback request.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a diagram of a system for providing access to a social media platform, in accordance with the disclosed embodiments;

FIG. 2 is a functional block diagram of a request surfacing system, in accordance with the disclosed embodiments;

FIG. 3 is a diagram of social media posts, in accordance with the disclosed embodiments;

FIG. 4 is a diagram of surfaced feedback requests, in accordance with the disclosed embodiments; and

FIG. 5 is a flow chart that illustrates an embodiment of a process for introducing requests in a social media environment.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

The subject matter presented herein relates to apparatus and methods used to surface aged feedback requests that have been submitted to a social media platform. A feedback request may be any social media post which requires a response from another user, or group of other users, to include without limitation: a question post, a poll post, an approval item post, or any other post requesting user feedback. Generally, social media posts (including feedback requests) appear in a social media feed in the order in which they were submitted to the system, with the most recently posted items appearing at the top of the feed or in another prominent position in the viewing area. A feed of posts includes posts from a user's connections, groups to which a user belongs, posts directed to the user specifically, posts from all users of the social media platform, or a group of posts adhering to any other feed configuration. Feeds may be filtered or narrowed based on user-configurable criteria.

The most recently added social media posts are initially viewable in the most prominent positions of a social media platform, and are shifted into less-prominent locations gradually as newer material is posted. Older social media posts eventually drop out of the immediate viewing area and out of the social media feed or page altogether after a threshold of time has passed. “Surfacing” an aged post may include relocating the older post to an end location of a feed (which may include the topmost position of the feed or a position at the bottom of a feed), as if it were a newly-posted material; presenting the older post to a user via another social media page or dashboard; presenting an indication that the older post is available to a user and remains incomplete, pending feedback; presenting the older post via email; presenting the older post in a digest of emailed updates; and/or presenting the older post in a new feed of surfaced content.

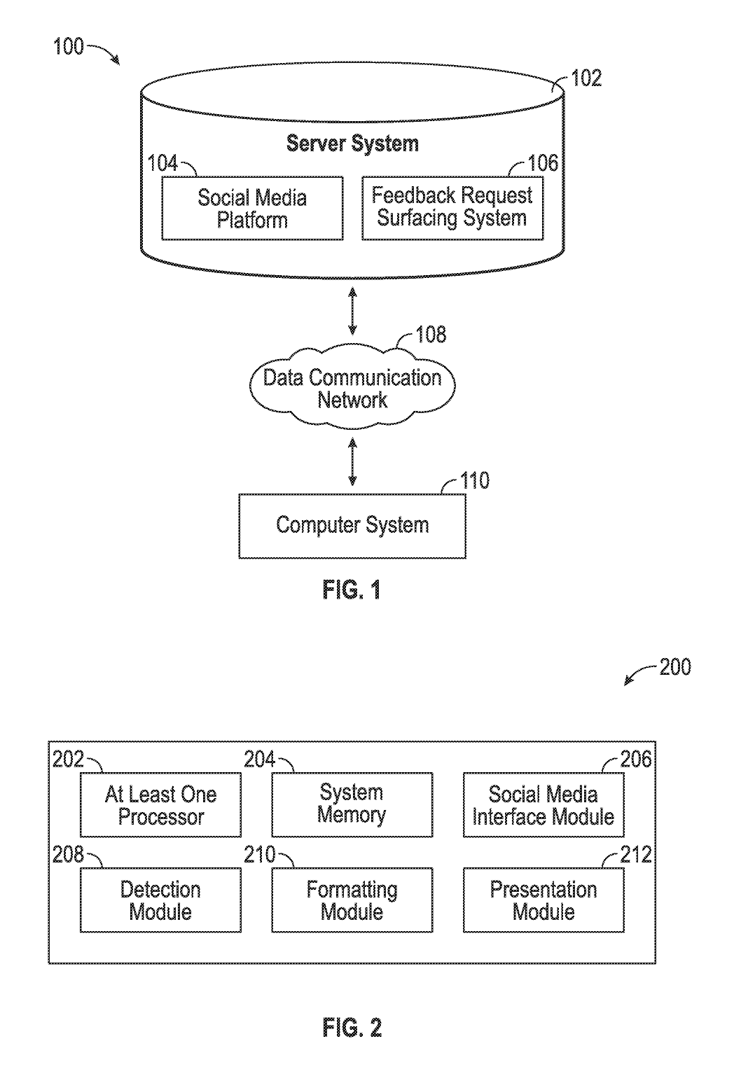

Turning now to the figures, FIG. 1 is a diagram of a system 100 for providing access to a social media platform 104, in accordance with the disclosed embodiments. As shown, the system 100 includes a computer system 110 for operation by a user. The computer system 110 may be implemented using a standalone personal computer, a portable computer (e.g., a laptop, a tablet computer, or a handheld computing device), a computer integrated into another device or system (e.g., a “smart” tv, a smartphone, or a smartwatch), or any other device or platform including at least one processor, some form of memory, and a user interface to allow a user to interact with the computer system 110. The user interface may include various human-to-machine interfaces, e.g., a keypad, keys, a keyboard, buttons, switches, knobs, a touchpad, a joystick, a pointing device, a virtual writing tablet, a touch screen, a microphone, or any device, component, or function that enables the user to select options, input information, or otherwise control the operation of the computer system 110.

The computer system 110 is capable of communicating with a remote server system 102 via a data communication network 108. The data communication network 108 may be any digital or other communications network capable of transmitting messages or data between devices, systems, or components. In certain embodiments, the data communication network 108 includes a packet switched network that facilitates packet-based data communication, addressing, and data routing. The packet switched network could be, for example, a wide area network, the Internet, or the like. In various embodiments, the data communication network 108 includes any number of public or private data connections, links or network connections supporting any number of communications protocols. The data communication network 108 may include the Internet, for example, or any other network based upon TCP/IP or other conventional protocols. In various embodiments, the data communication network 108 could also incorporate a wireless and/or wired telephone network, such as a cellular communications network for communicating with mobile phones, personal digital assistants, and/or the like. The data communication network 108 may also incorporate any sort of wireless or wired local and/or personal area networks, such as one or more IEEE 802.3, IEEE 802.16, and/or IEEE 802.11 networks, and/or networks that implement a short range (e.g., Bluetooth) protocol. For the sake of brevity, conventional techniques related to data transmission, signaling, network control, and other functional aspects of the systems (and the individual operating components of the systems) may not be described in detail herein.

The server system 102 operates the social media platform 104 and feedback request surfacing system 106. The server system 102 may include any number of application servers, and each server may be implemented using any suitable computer. In some embodiments, the server system 102 includes one or more dedicated computers. In some embodiments, the server system 102 includes one or more computers carrying out other functionality in addition to server operations. In exemplary embodiments, the server system 102 operates within a client-server architecture, executing programs to serve the requests of other programs (i.e., the clients). In this example, the computer system 110 acts as the client, and the server system 102 performs some tasks on behalf of computer system 110, to include providing a social media platform 104.

One or more application servers of the server system 102 maintain the social media platform 104. The social media platform 104 includes a web-based social media interface which enables users to interact over the Internet or an intranet. Such interactions are made available to the user via user-accessible functionality of the social media interface. User-accessible functionality may include, without limitation: posting “status updates” to a feed, posting messages to a profile page, private messaging (e.g., email), instant messaging, tagging users in posts and/or messages, sharing documents or other files, and the like. Social media functions may be performed by individual users of the social media platform 104 or within specialized groups associated with the social media platform 104. In some embodiments, the entire social media platform 104 may be specialized and operate as a tool for users of a particular organization. The social media platform 104 may incorporate communication tools such as mobile connectivity, photo and video sharing, and blogging. The social media platform 104 allows users to share ideas, pictures, posts, activities, events, and interests with other users in their network. Examples of a social media platform 104 may include, without limitation: Facebook, Google+, LinkedIn, Instagram, Reddit, Pinterest, Vine, Tumblr, and Twitter. In one embodiment, for example, the environment is implemented using the Chatter® collaboration platform provided by Salesforce.com, Inc. of San Francisco, Calif.

The social media platform 104 is configured to interact with a feedback request surfacing system 106, as described below with regard to FIG. 2. The feedback request surfacing system 106 surfaces an aged feedback request, or in other words, brings an unanswered post (which requires response) to the attention of another user to encourage and facilitate feedback.

FIG. 2 is a functional block diagram of a feedback request surfacing system 200, in accordance with the disclosed embodiments. The feedback request surfacing system 200 generally includes, without limitation: at least one processor 202; system memory 204; a social media interface module 206; a detection module 208; a formatting module 210; and a presentation module 212. These elements and features of the feedback request surfacing system 200 may be operatively associated with one another, coupled to one another, or otherwise configured to cooperate with one another as needed to support the desired functionality—in particular, surfacing feedback request posts which have not received adequate response, as described herein. For ease of illustration and clarity, the various physical, electrical, and logical couplings and interconnections for these elements and features are not depicted in FIG. 2. Moreover, it should be appreciated that embodiments of the feedback request surfacing system 200 will include other elements, modules, and features that cooperate to support the desired functionality. For simplicity, FIG. 2 only depicts certain elements that relate to the feedback request surfacing techniques described in more detail below.

The at least one processor 202 may be implemented or performed with one or more general purpose processors, a content addressable memory, a digital signal processor, an application specific integrated circuit, a field programmable gate array, any suitable programmable logic device, discrete gate or transistor logic, discrete hardware components, or any combination designed to perform the functions described here. In particular, the at least one processor 202 may be realized as one or more microprocessors, controllers, microcontrollers, or state machines. Moreover, the at least one processor 202 may be implemented as a combination of computing devices, e.g., a combination of digital signal processors and microprocessors, a plurality of microprocessors, one or more microprocessors in conjunction with a digital signal processor core, or any other such configuration.

The at least one processor 202 communicates with system memory 204. The system memory 204 may be realized using any number of devices, components, or modules, as appropriate to the embodiment. In practice, the system memory 204 could be realized as RAM memory, flash memory, EPROM memory, EEPROM memory, registers, a hard disk, a removable disk, or any other form of storage medium known in the art. In certain embodiments, the system memory 204 includes a hard disk, which may also be used to support functions of the at least one processor 202. The system memory 204 can be coupled to the at least one processor 202 such that the at least one processor 202 can read information from, and write information to, the system memory 204. In the alternative, the system memory 204 may be integral to the at least one processor 202. As an example, the at least one processor 202 and the system memory 204 may reside in a suitably designed application-specific integrated circuit (ASIC).

The social media interface module 206 may include or cooperate with various features to allow a user to interact with the feedback request surfacing system 200 via a social media platform connected to a server system (described previously with respect to FIG. 1). Accordingly, the social media interface module 206 may initiate the creation and maintenance of a graphical user interface (GUI), rendered on a display element. In certain embodiments, the display element implements touch-sensitive technology for purposes of interacting with the GUI. Thus, a user can manipulate the GUI by moving a cursor symbol rendered on the display element, or by physically interacting with the display element itself for recognition and interpretation. Using input keyboard commands and/or touch-screen commands (among other types of input commands), the user could manipulate the GUI to interact with a social media platform to access and view various social media pages; to create social media posts and submit or “post” them to a particular page or a particular social media feed, and to view social media feeds containing posts including status updates, messages, feedback requests, and shared content.

Social media pages, presented by the social media interface module 206, may include content specific pages, profile pages, “home” pages, “dashboard” pages, or the like. Content specific pages may include content directed to a particular topic. A profile page is a page describing a particular user and/or including posts and shared content directed to that user. A “home” page may be a main page from which a user may participate in social media activities, such as reading a main news feed, posting status updates, reading notifications, etc. A dashboard page is a page showing a personalized snapshot of a user's social media account, activity of the user's connections, notifications, and other relevant or recent items which may be of interest to the user. A feed of posts may be presented on any type of social media page, including those described above. Generally, a feed of posts includes posts from a user's social media connections and social media groups. In some embodiments, a feed may include posts from all users of a particular social media platform. Feeds may also be reduced or narrowed by filtering the feed. For example, a user may view a feed of posts submitted by every social media connection of the user. As another example, a user may view a feed of posts submitted by every connection of the user who is also affiliated with a particular social media group. In another example, a user may view a feed of posts in which the viewing user is “tagged” by the posting user.

The social media interface module 206 is further configured to display social media elements which may appear on any social media page, to include a notification of social media activity. A notification indicator is usually a graphical element designed to attract the attention of a user, presented as a hyperlink to directly access information related to social media activity which may be of interest to the user. Examples of social media activity for which a notification might be generated include a submitted post in which the user was tagged; a reminder for an upcoming event or meeting; an increased number of responses to a user post or post in a group to which the user belongs; or other social media activities associated with the user.

The detection module 208 is configured to detect an incomplete feedback request that has been previously submitted to a social media platform. Once submitted to the social media platform, the incomplete feedback request is stored in system memory 204 and is maintained by the social media platform. Social media posts (including feedback requests) that have been stored by the social media platform may be presented by the social media interface in various locations and capacities. General techniques for display of social media posts are well-known and will not be described in more detail herein.

A feedback request is any user post requiring responses from one or more users, other than the user that posted the feedback request to the social media platform. Exemplary embodiments of feedback requests may include, without limitation: question posts, poll posts, and approval item posts. It should be appreciated that question posts, poll posts, approval item posts, and any corresponding logical elements, individually or in combination, are exemplary means for requesting feedback and are exemplary embodiments of appropriate posts for which the surfacing techniques described herein may be applied. Surfacing techniques may also be applied to other types of social media posts requiring responses from other users.

In certain embodiments, a feedback request is “incomplete” when it lacks any response from users of the social media platform. One example of this type of incomplete feedback request may be an unanswered question post. In some embodiments, the feedback request is “incomplete” when it lacks the required number of responses. An example of this type of incomplete feedback request may be a poll post which requires at least twenty responses, but which has received only ten responses.

The detection module 208 detects incomplete feedback requests in a social media feed, or in a database, data structure, or any other storage location configured to retain user posts in system memory 204. An applicable social media feed may be an all-encompassing feed of all posts submitted to the social media platform, or the feed may be a filtered or narrowed version of a feed which applies only to certain users, certain groups, or certain content. In either applicable environment, the detection module 208 evaluates a plurality of social media posts to identify incomplete feedback requests.

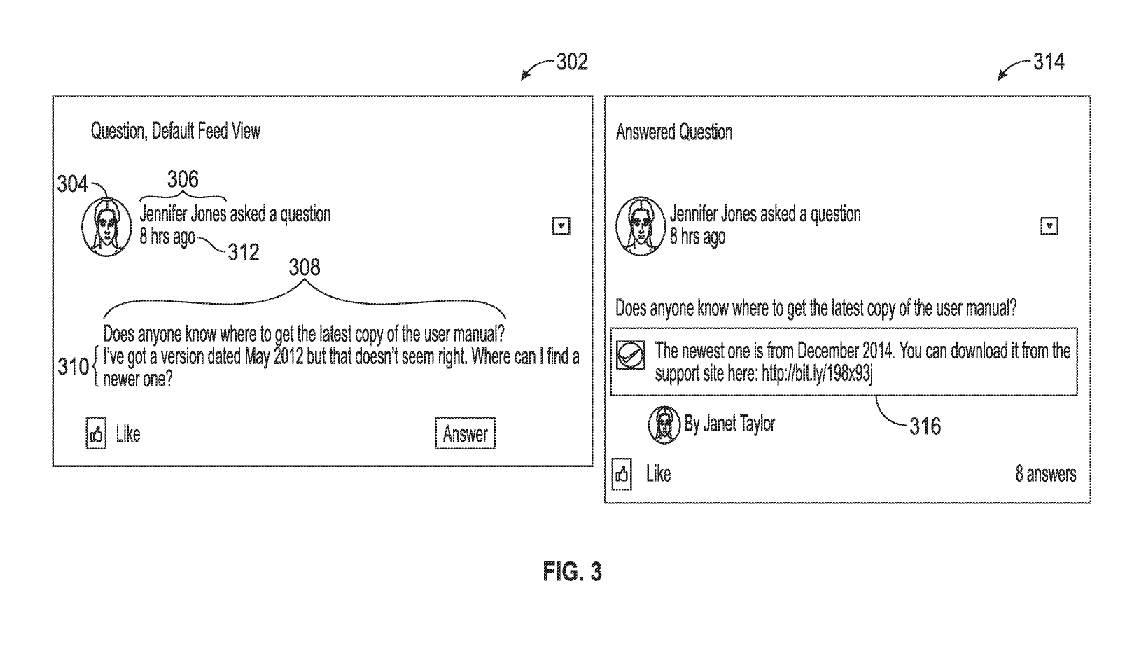

An exemplary embodiment of a feedback request may be a question post, as shown in FIG. 3. As shown, a question post 302 is presented in a similar fashion to a social media post with an appearance that is standard to many social media platforms. The question post 302 includes a profile picture 304 of the posting user, the name 306 of the posting user, the text of the question 308 itself, and a clarifying comment 310 posted by the posting user. The question post 302 further includes a timestamp 312, which may include the actual time of posting or a time value relative to the current time (e.g., “8 hrs ago”). The question post 302 also includes options to “like” the question post 302, or to provide an answer to the question post 302. As shown, the question post 302 has not received any responses. As such, the question post 302 is termed “incomplete” or, in other words, is lacking response.

The question post 302 is also shown as an answered question post 314. Here, the answered question post 314 is the same as the incomplete question post 302 in all respects, except that the answered question post 314 includes an answer 316 from another user. In this case, the answer includes text and a link to the document requested in the question post 302 (e.g., the latest copy of the user manual). Because the answered question post 314 has received an answer from another user, it is termed “complete”, and requires no surfacing or re-presentation to obtain the required feedback.

It should be appreciated that FIG. 3 depicts simplified embodiments of complete and incomplete feedback requests, and that a realistic and practical implementation of a feedback request may include additional features or graphical elements. For example, a poll post may include user-selectable buttons, bullet-points, check-boxes, or the like. As another example, an approval item may include a check-box or “approve” button.

Returning to FIG. 2, the detection module 208 may only detect aged incomplete feedback requests. In this case, incomplete feedback requests are only detected if they were posted after a certain date or within a predetermined window of time. The predetermined window of time may be configured at design time, or it may be a user-configurable value. The purpose of the predefined window of time is to provide a time period during which the feedback request must have been posted in order to qualify for detection, re-packaging, and re-presentation (by the detection module 208, the formatting module 210, and the presentation module 212, respectively). The predefined window of time is configured to locate old feedback requests which have not yet been answered or which have not yet received the requisite number of responses to qualify as “complete”.

The formatting module 210 is configured to reformat an incomplete feedback request to attract the attention of one or more users. To attract a user's attention, the formatting module 210 may use one or more of the following techniques: (1) text formatting techniques; and (2) text that is targeted to a particular user. Text formatting techniques may include bold text, large sized text, text with a distinguishing font, text with a distinguishing color, highlighting, shading, or the like. Other formatting techniques may include the use of flashing icons, pictures, or letters, or any graphical element or feature which may be used to attract the attention of a user.

The formatting module 210 may use targeted language to attract the attention of a specific user, such as a direct plea using a person's name. In certain embodiments, the formatting module 210 accomplishes this objective using a text-wrapper that includes wording such as, for example, “Joe, can you answer this question?”, or “Jane, can you answer the question presented below?” One of the main objectives in reformatting an incomplete feedback request is to present the reformatted post as a personal request for a response. Although the incomplete feedback request may be reformatted and re-presented to a plurality of users, each user receives the reformatted post as a personal call to action that uses his/her name. The feedback request surfacing system 200 uses the personal call to action to elicit feedback that might otherwise not be provided.

The presentation module 212 is configured to receive (via the formatting module 210) and display at least one incomplete feedback request that has been reformatted. The presentation module 212 cooperates with the social media interface module 206 to display the reformatted incomplete feedback requests to a user as a “new” post in the prominent location(s) normally reserved for the most recently posted social media content. In some embodiments, the presentation module 212 displays the new post at the top of a social media feed. In some embodiments, the presentation module 212 displays the new post on a homepage or “dashboard” page. In some embodiments, the presentation module 212 displays a notification indicator for the user to view and recognize that an incomplete feedback request is waiting for his attention. In this example, when the user clicks the notification indicator, the user is presented with the reformatted incomplete feedback request, and the user may provide a response at that point. In some embodiments, the presentation module 212 displays the reformatted incomplete feedback request as a standalone item or as part of a digest of content in an email. In some embodiments, the presentation module 212 displays the reformatted incomplete feedback request in a new feed of social media posts, the new feed featuring surfaced content.

In practice, the social media interface module 206, the detection module 208, the formatting module 210, and/or the presentation module 212 may be implemented with (or cooperate with) the at least one processor 202 to perform at least some of the functions and operations described in more detail herein. In this regard, the social media interface module 206, the detection module 208, the formatting module 210, and/or the presentation module 212 may be realized as suitably written processing logic, application program code, or the like.

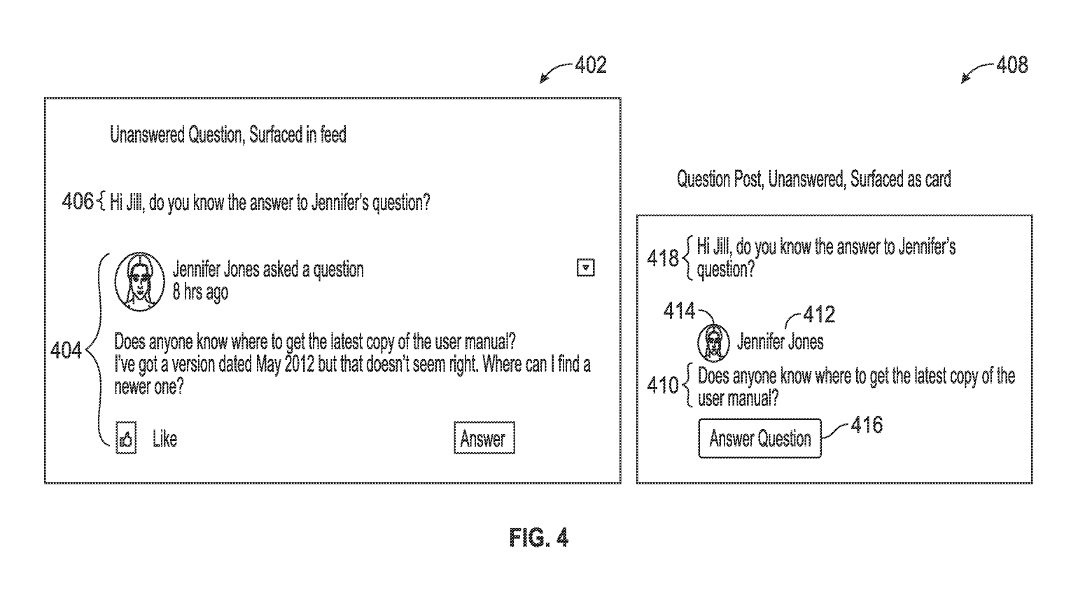

An exemplary embodiment of a reformatted feedback request is presented in FIG. 4. As shown, an unanswered question post appears as a reformatted post 402. The reformatted post 402 includes a question post 404 in its entirety, as described previously with regard to FIG. 3. The reformatted post 402 also includes a call to action 406, which is presented above the question post 404 and in a larger font. Here, the call to action 406 specifically addresses a user named Jill, and uses the text “Hi Jill, do you know the answer to Jennifer's question?” to attract the attention of Jill and to encourage Jill to provide a response to the presented question post 404. The reformatted post 402 includes the features of a standard social media post and may appear in a social media feed. In certain embodiments, once the question post 404 has been reformatted to produce a reformatted post 402, the reformatted post 402 is surfaced, or in other words, re-presented at the top of a social media feed as a new post.

A reformatted feedback request may also be presented as a reformatted card 408. In this example, the reformatted card 408 includes the text of the question 410, the name 412 of the posting user, and the profile picture 414 of the posting user, but the remaining features associated with a social media post (e.g., a “like” selector, a timestamp, a listing of other comments/feedback, etc.) are not presented. The reformatted card 408 presents the question 410 itself and a user-selectable option 416 to provide an answer. The reformatted card 408 also presents a call to action 418 which, similar to the previously-described call to action 406, identifies the user Jill by name and inquires as to whether Jill might know the answer to the posted question. The reformatted card 408 may appear as a graphical element in a sidebar of a social media page, on a “dashboard” page which presents a snapshot of current social media activity applicable to the currently logged-in user, on a “homepage” that is presented to a user once logged into the social media platform, or on any other social media page and location available for presentation of a reformatted card 408.

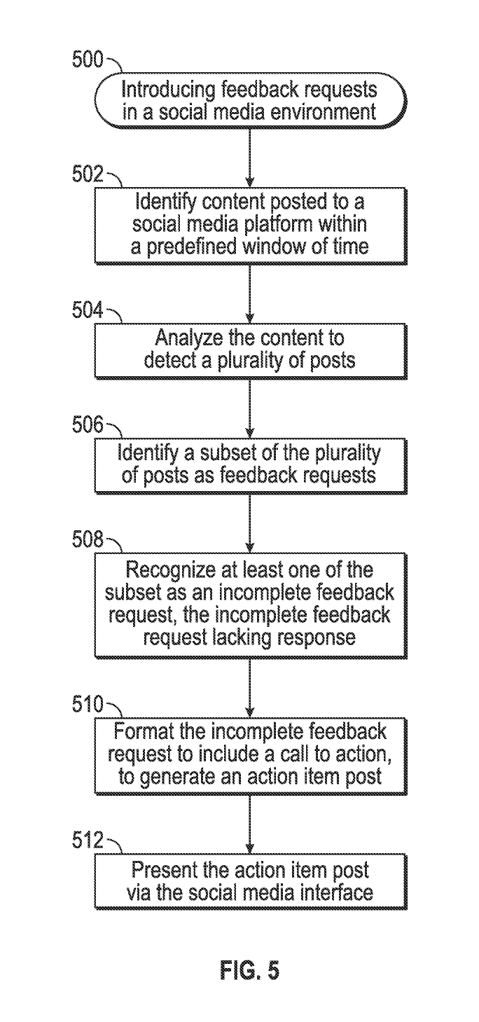

FIG. 5 is a flow chart that illustrates an embodiment of a process 500 for introducing feedback requests in a social media environment. The various tasks performed in connection with process 500 may be performed by software, hardware, firmware, or any combination thereof. For illustrative purposes, the following description of process 500 may refer to elements mentioned above in connection with FIGS. 1-4. In practice, portions of process 500 may be performed by different elements of the described system. It should be appreciated that process 500 may include any number of additional or alternative tasks, the tasks shown in FIG. 5 need not be performed in the illustrated order, and process 500 may be incorporated into a more comprehensive procedure or process having additional functionality not described in detail herein. Moreover, one or more of the tasks shown in FIG. 5 could be omitted from an embodiment of the process 500 as long as the intended overall functionality remains intact.

For ease of description and clarity, this example assumes that the process 500 begins by identifying content submitted to the social media platform within a predefined window of time (step 502). The content includes all social media posts submitted to the system for posting during the predefined window of time. The content may include shared pictures, videos, or links; text-based status updates; messages; thanking posts; record change posts; or the like. In some embodiments, the content includes social media content that was posted to a social media feed within the predetermined window of time.

A post is positioned based on the date and time it was originally submitted to the social media platform, and this position continuously shifts as new posts and new content (with more recent dates and/or times) are shared via the social media interface. Here, the process 500 identifies older posts (i.e., aged posts) by accessing only those posts associated with date-stamps and/or timestamps that are older than a threshold. The process 500 also keeps the number of social media posts searched and analyzed to a level that is manageable by setting a second time/date threshold. The process 500 uses the second threshold as a date/time cutoff, and only those posts that are newer than the second threshold are evaluated. The first and second thresholds act as boundaries for the predefined window of time, to achieve the objective of searching and analyzing a practical quantity of older posts.

In certain embodiments, the predefined window of time is determined when the system is designed, and may include any designer-selected period of time. In certain embodiments, this period of time may include a cutoff time (first threshold) after which the unanswered feedback request drops out of view on most users' feeds. In some embodiments, the predefined window of time may be user-configurable, wherein a user may select a period of time from which unanswered questions may be surfaced in his own feed. A user may choose a particular window of time based on his absence from accessing the social media platform for a particular period of time. For example, the user may have taken a vacation and did not access the social media platform for a week. Upon logging into the social media platform, the user may wish to view posts and content that he missed during the vacation time. In this case, the user may select to view unanswered feedback requests that were posted during the time period that the user was on vacation and not logged into the social media platform.

Next, the process 500 analyzes the submitted content to detect a plurality of posts (step 504). In some embodiments, the process 500 analyzes a storage location or data structure for social media posts associated with a social media platform, the social media posts including content that has been “shared”, or submitted to the social media platform for distribution to a social media audience. Here, the process 500 analyzes the portion of the storage location associated with the predetermined window of time. In some embodiments, the process 500 analyzes a social media feed of social media posts for the predetermined window of time. The process 500 has identified a “shortened” feed of social media content, delimited by the boundaries for the predefined window of time (step 502). Here, the process 500 analyzes this shorter feed, which contains a significantly smaller amount of content for analysis, and detects the existence of each individual post of the shorter feed.

The process 500 then identifies a subset of the plurality of posts as feedback requests (step 506). Each of the detected social media posts is associated with a type that is readily recognized by the process 500. The process 500 evaluates the plurality of social media posts, based on type, to identify feedback requests. Types may include, without limitation: status updates, content sharing (e.g., links, pictures, video, blog posts, etc.), tracked changes to a record or document, a profile skill update, a “thanking” post, a social post linking and/or showing a post from another social media network, a milestone post, an email post, a dashboard alert post, a created event post, logging a call post, a “sticky” announcement post, a chat transcript post, or a feedback request post. Feedback request posts may include question posts, poll posts, approval items, or any other type of social media post requiring a response from users other than the user that posted the item.

After identifying the subset of the plurality of posts as feedback requests (step 506), the process 500 recognizes at least one of the subset as an incomplete feedback request, the incomplete feedback request lacking response (step 508). Each feedback request posted during the predefined window of time may or may not have received responses. To be classified as “incomplete”, a feedback request may lack any response at all, or may lack an adequate number of responses. For example, the incomplete feedback request may include an unanswered question post. As another example, the incomplete feedback request may include a poll post that has received less than the required number of responses. In this case, the poll may require five responses, but only three responses were provided. In a third example, the incomplete feedback request may include an approval item that has not yet received approval or comments.

The process 500 then formats the incomplete feedback request to include a call to action, to generate an action item post (step 510). Here, the process 500 leaves the original feedback request intact, but incorporates additional text for the re-presentation of the feedback request. This additional text (i.e., the “call to action”) may be implemented as a text-wrapper or announcement accompanying the feedback request. The process 500 may also use text formatting, highlighting, shading, and differentiating font size for the call to action and/or the feedback request, to attract the attention of the user and to encourage feedback from the user.

The process 500 may also use personalization for the call to action, wherein the process 500 uses the name of a particular user to attract the attention of that particular user, and to encourage that particular user to provide a response. In some embodiments, the process 500 evaluates users of the social media platform to determine a set of the users affiliated with a topic of the incomplete action item, and personalizes the action item post for the determined set of users. In some cases, the determined set of users may include one user in particular. In other situations, the determined set of users may include a plurality of users. For example, when the original feedback request is a question, poll, or approval item associated with Project X, the determined set of users may include all participants and supervisors associated with Project X. Here, the process 500 may personalize a call to action to include “Hi, Project X member! Can you answer the question below?” The process 500 may also retrieve names for each user associated with Project X, and may personalize each call to action with a particular name, while only producing the reformatted action item post for those associated with Project X.

For example, referring back to FIG. 4, a feedback request, such as a question post 404, may include the wording, “Does anyone know where to get the latest copy of the user manual?” An exemplary embodiment of a call to action 406, implemented as a text-wrapper, may include the personalized wording “Hi Jill, do you know the answer to Jennifer's question?” Here, the call to action 406 is shown above the question post 404, and has been formatted to include text that is larger than the text in the question post 404, and also includes a specific and targeted user's name, “Jill”. In this exemplary embodiment, the reformatted post 402 appears in a prominent location in the social media interface, such as at the top of a feed of posts, in a sidebar of a homepage or dashboard page, and/or may appear or become available when the user Jill clicks on a notification indicator. The reformatted post 402 may also be presented in an email or in a feed of posts filtered to feature surfaced content. Another exemplary embodiment, also shown in FIG. 4, includes the feedback request presented as a reformatted card 408, which also includes a personalized call to action 418 which has been formatted to include larger text than the original question 410. Similar to the reformatted post 402, the reformatted card 408 may also be presented in any location of the social media interface.

After generating the action item post (step 510), the process 500 presents the action item post via the social media interface (step 512). This presentation of the action item post is called “surfacing”, because it retrieves an “old” post from a less-prominently displayed position and re-presents the post as a new post, as if the post were just submitted. A post is positioned based on the date and time it was originally submitted to the social media platform, and this position continuously shifts as new posts and new content (with more recent dates and/or times) are shared via the social media interface.

For a particular user, the process 500 may present the new post in the position or location of a most-recently-submitted post. For example, the process 500 may display the action item post at a topmost location in the social media feed, when the topmost location is associated with most recently posted content. In some embodiments, the process 500 displays the action item post in a social media dashboard, the dashboard comprising a separate page showing a display of social media activity distinct from the social media feed. In this embodiment, the social media environment includes at least the social media dashboard and the social media feed. In some embodiments, the process 500 displays a notification indicator via the social media environment, after generating the action item post. In this example, the notification indicator comprises a graphical element hyperlinked to the generated action item post, so that a user can click on the notification indicator to access the action item post.

In certain embodiments, the process 500 does not present the reformatted action item post to all users of a social media platform. In this case, the process 500 determines which users can view the reformatted action item post, and presents the new post in a prominent position used for the most-recently-posted content (as described above), but only to applicable users. Here, the process 500 evaluates users of the social media platform to determine a set of the users affiliated with a topic of the incomplete action item, and presents the action item post to the determined set of users. Affiliation with the topic may include any criteria, including, without limitation: membership in a particular social media group, participation in a project, collaboration for an assignment, employment with a particular organization, or any characteristic or criterion available for evaluation within the social media platform.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. A module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

1.-20. (canceled)

21. A method for introducing action items via a social media interface of a social media platform, the method comprising:
detecting, at a server, an incomplete feedback request submitted to the social media platform, wherein the incomplete feedback request lacks response, and wherein the social media platform is connected to the server;
generating an action item post from the incomplete feedback request; and
providing, by the server over a network, the action item post via the social media interface.

22. The method of claim 21, further comprising:
formatting, at the server, the incomplete feedback request to include a call to action, to generate the action item post.

23. The method of claim 21, wherein the detecting step further comprises:
analyzing the social media platform to detect a plurality of posts;
identifying a subset of the plurality of posts as feedback requests; and
recognizing at least one of the subset as the incomplete feedback request.

24. The method of claim 23, further comprising:
identifying content posted to the social media platform within a predefined window of time; and
performing the analyzing step using the identified content.

25. The method of claim 21, wherein the incomplete feedback request is selected from a group consisting of: a question post, a poll post, and an approval item post.

26. The method of claim 21, wherein the providing step further comprises:
displaying the action item post at an end location in a feed of the social media platform;
wherein the end location is associated with most recently posted content.

27. The method of claim 21, wherein the providing step further comprises:
displaying the action item post at a social media dashboard of the social media platform, the dashboard comprising a personalized snapshot page describing social media activity.

28. The method of claim 21, wherein the providing step further comprises:
displaying a notification indicator via the social media interface, after generating the action item post;
wherein the notification indicator comprises a graphical element hyperlinked to the generated action item post.

29. A system for introducing feedback requests in a social media platform, the system comprising:
a social media interface presented by a server over a network, the social media interface configured to:
receive, and communicate to the server, user input comprising social media activity; and
display social media posts submitted to the social media platform, the social media platform being connected to the server;
a detection module of the server, configured to detect an incomplete feedback request submitted to the social media platform, wherein the social media posts comprise at least the incomplete feedback request; and
a presentation module of the server, configured to display the incomplete feedback request as a new social media post.

30. The system of claim 29, further comprising:
a formatting module of the server, configured to reformat the incomplete feedback request to include a text-wrapper;
wherein the presentation module is configured to display the incomplete feedback request after reformatting.

31. The system of claim 29, wherein the detection module is further configured to:
detect a plurality of the social media posts submitted to the social media platform;
identify a subset of the plurality of social media posts as feedback requests; and
recognize at least one of the subset as the incomplete feedback request.

32. The system of claim 31, wherein the detection module is further configured to:
identify content posted to the social media platform within a predefined window of time; and
analyze the identified content to detect the plurality of social media posts, wherein the content comprises the subset.

33. The system of claim 29, wherein the presentation module is further configured to display the new social media post in a position in a feed of the social media platform, the position being associated with most recently posted content.

34. The system of claim 29, further comprising:
an evaluation module, configured to determine a topic of the incomplete feedback request, and to identify a set of users associated with the topic;
wherein the presentation module is further configured to present the new social media post to the set of users.

35. A non-transitory, computer-readable medium containing instructions thereon, which, when executed by a processor, are capable of performing a method comprising:
identifying an aged feedback request submitted to a social media platform connected to a server, wherein the aged feedback request lacks a required number of responses; and
presenting, by the server, the aged feedback request as a new feedback request.

36. The non-transitory, computer-readable medium of claim 35, wherein the method further comprises formatting, at the server, the aged feedback request to include a call to action for a particular user, prior to the presenting step; and
wherein the new feedback request comprises the aged feedback request after formatting.

37. The non-transitory, computer-readable medium of claim 36, wherein the method further comprises:
evaluating, at the server, users of the social media platform to determine a set of the users associated with a topic of the aged feedback request;
wherein the presenting step is performed based on the determined set; and
wherein the determined set of users comprises the particular user.

38. The non-transitory, computer-readable medium of claim 35, wherein the aged feedback request is selected from a group consisting of: a question post, a poll post, and an approval item post.

39. The non-transitory, computer-readable medium of claim 35, wherein the method further comprises:
prior to the identifying step, analyzing the social media platform to detect a plurality of posts;
identifying a subset of the plurality of posts as feedback requests; and
recognizing at least one of the subset as the aged feedback request.

40. The non-transitory, computer-readable medium of claim 39, wherein the method further comprises:
identifying content posted to the social media feed within a predefined window of time; and
performing the analyzing step using the identified content.
